(19) United States
(12) Patent Application Publication
(10) Pub. No.: US 2008/0050496 A1
(43) Pub. Date: Feb. 28, 2008

(54) Mixing apparatus

(76) Inventors: Dorin Boldor, Baton Rouge, LA (US); Erik A. Durr, Baton Rouge, LA (US); Yin-Lin Chiu, Denham Springs, LA (US)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 11/509,940

(22) Filed: Aug. 25, 2006

(51) Int. Cl. A23J 3/00

(52) U.S. Cl. 426/569

(57) ABSTRACT

An apparatus and method of combining and mixing in precise proportions two or more chemicals or compounds is disclosed. The basic design of the apparatus comprises an operator control system, a drive motive assembly, one or more mixing chamber assemblies, and a cooling system. Suitable proportions of each chemical or compound may be controlled with relatively high precision. In one embodiment, the mixing chamber assemblies each comprise at least one static mixer having a plurality of perforations encased in an outer air-injection jacket. In this embodiment, the apparatus is used to make a cool, stabilized foam product, (e.g., whipping cream) infused with an alcoholic beverage without the need for adding supplemental foam stabilizing agents (e.g., polypropylene glycol alginate or pectin) to the product.

This invention pertains to mixers, more particularly an apparatus and method of mixing two or more chemicals or compounds in precise proportions, such as a combination of alcohol, fat, and protein to form a stabilized emulsion or foamed product infused with an alcoholic beverage.

Products containing alcohol, fat and protein in emulsion form are not readily foamable due to the destabilizing effects of alcohol on the foam. Known foam stabilizing agents such as polypropylene glycol alginate and pectin are ineffective in producing foam stability in a product containing alcohol, fat, and protein, which is foamed. See, generally, U.S. Pat. No. 4,943,443.

U.S. Pat. No. 6,119,582 describes an apparatus for preparing coffee extract having a small-bubbled foam layer comprising at least one inlet having at least one spout opening for generating a coffee extract jet when coffee extract is fed to the inlet, one outflow opening for discharging coffee extract having a small-bubbled foam layer, a liquid flow path extending between the inlet and the outflow opening, and a buffer reservoir extending from the spout opening and the outflow opening. In this embodiment, small bubbles are created in the coffee extract by jetting the coffee extract from the outlet spouts into a liquid surface of coffee extract already received in the buffer reservoir.

U.S. Pat. No. 5,925,394 describes an apparatus and method for producing an expanded foam food product containing an alcohol beverage from denatured mammal foodstuff (e.g., skim milk, whole milk, light cream, evaporated milk, and reconstituted dried milk) or bird foodstuff (e.g., whole egg, reconstituted powdered egg white, egg yolk, and reconstituted powdered egg yolk) comprising the steps of mixing the bird food stuff with an alcoholic beverage; heating at least one of the denaturable mammal or bird foodstuffs to its denaturing temperature; and whipping the denaturable foodstuff into an expanded foam product, that is at least twice the volume of the unwhipped foodstuff, while the denaturing is carried out, using a high-speed hand mixer.

U.S. Pat. No. 5,118,520 describes a method of producing a foamed nonfat seasoning using a foamed-liquid generating and squeezing container comprising the steps of adding an emulsifier and 3-10 weight % ethanol to a nonfat aqueous seasoning (e.g., soups, steak sauce, liquid stock from bonito or dried small sardines, sweet sake, seasoning extracts, and non-oil dressing) to obtain a foamable seasoning and to enhance the foam formation of the foamable seasoning; and forcing a gas through the foamable seasoning to form a foamed seasoning. In one embodiment, the foamable seasoning is forcibly admixed with air to foam the liquor by means of a homogenizer.

U.S. Pat. No. 4,943,443 describes a process for producing a foamed alcoholic product containing alcohol, fat, and protein, comprising the steps of mixing an effective amount of a calcium source, protein, fat, water, and a foam stabilizing agent (e.g., polyphosphates and lactates); emulsifying the mixture by homogenization at a pressure of approximately 25-150 kg/cm² and a temperature of approximately 60° C.-110° C.; cooling the mixture to a temperature below 5° C.; adding an aqueous alcoholic composition to the mixture; and foaming the mixture using various means, including manual whipping devices, electric whipping devices or an aerosol container.

U.S. Pat. Nos. 4,144,293 and 4,168,727 describe a device for making an emulsified product from a mixture of a gas and liquid milk product capable of forming a foam, comprising a suction pump having a discharge port and a mixing chamber for mixing the liquid milk product with the gas, a fixed whipping barrel having one end connected to the discharge port and a substantially labyrinth passage defined therein for emulsifying the mixture, and a rotary whipping barrel comprising a hollow cylinder having one end in communication with the fixed whipping barrel and a stirring rod housed within the hollow cylinder for stirring the emulsified milk product.

U.S. Pat. No. 4,046,358 describes an apparatus and method for mixing products which require two or more component chemicals or compounds that must be mixed together immediately prior to use, comprising the steps of mixing the compounds inside a mixing chamber by continuously supplying each of the compounds to the mixing chamber; introducing air into the chamber while maintaining the chamber open at one end for the dispensing of the material. In one embodiment, the air provides agitation for the mixture of materials and provides suction forwardly of the mixing chamber to draw out the mixed compounds.

U.S. Pat. No. 3,554,771 describes a method for converting an alcoholic beverage (e.g., cordials, brandies, rums or whiskeys) into an edible, flowable solid gel or foamy gel-form comprising the steps of adding a gelating agent to the alcoholic beverage to solidify the beverage; encasing the solidified beverage in a pressure-resistant container having an outlet valve together with a non-toxic propellant gas (e.g., nitrous oxide, dichlor difluor methane, perfluoro cyclobutane, and carbon dioxide); and expanding and releasing the solidified beverage from the container by manipulating the outlet valve.

A need exists for an apparatus and method of mixing an alcoholic beverage, calcium, fat, and protein to form a stabilized emulsion or foamed product infused with the alcoholic beverage.

Additionally, other products, which require the mixing of two or more chemicals or compounds in precise proportions, are increasingly being used in various industries besides the food industry, e.g. pharmaceutical and oil and gas industries. A need exists for an apparatus capable of mixing these chemicals or compounds in precise proportions.

We have discovered an apparatus and method of combining and mixing in precise proportions two or more fluids, including chemicals and compounds. The apparatus may be adapted to homogenize a product containing a combination of an alcoholic beverage, calcium, fat, and protein, and to continuously form a stabilized emulsion or foamed product infused with the alcoholic beverage. The basic design of the apparatus comprises an operator control system, a drive motive assembly, one or more mixing chamber assemblies, and a cooling system. Suitable proportions of each fluid may be controlled with relatively high precision. In one embodiment, the mixing chamber assemblies each comprise at least one static mixer having a plurality of perforations encased in an outer air-injection jacket. In this embodiment, the apparatus is used to make a cool, stabilized foam product, (e.g., whipping cream, i.e., a product containing substantially no spherical fat particles having a particle diameter of 1 μm or greater, or containing 10% or more of spherical fat particles having a particle diameter of 0.1 μm or smaller, or containing 20% by volume or more of spherical fat particles having a particle diameter of 0.4 μm or smaller), infused with an alcoholic beverage, i.e., any fluid or solid capable of being converted into a fluid suitable for human consumption and having an alcoholic content of more than 6% by volume, including alcohol (e.g., Baileys® Irish Cream, Jameson Irish Whiskey, Carmichaels Irish Cream, etc.) without the need for adding foam stabilizing agents (e.g., polyphosphates, lactates, polysaccharides and mixtures thereof) or supplemental foam stabilizing agents (e.g., polypropylene glycol alginate or pectin) to the product. In this embodiment, cream and a flavoring agent and/or alcoholic beverage are mixed, and then injected into the mixing chamber. Sweeteners and colorings may also be added to the foamable product. Next, pressurized air or other gases such as nitrous oxide, carbon dioxide, or nitrogen is introduced into the air-injection jacket and enters the static mixer through a plurality of pinholes to foam the mixture.

### BRIEF DESCRIPTION OF THE DRAWINGS

FIG. 1 illustrates schematically a block diagram of the major components of one embodiment of the mixing and foaming apparatus.

FIG. 2 is a perspective view of one embodiment of the mixing chamber assembly.

FIG. 3 is a front plan view of one embodiment of the static mixer.

A general purpose of this invention is to provide a self-contained apparatus and means for combining and mixing suitable proportions of two or more liquids, chemicals or compounds. The basic design comprises an operator control system, a drive motive assembly, one or more mixing chamber assemblies, and a cooling system. In one embodiment, the mixing chamber assemblies each comprise at least one static mixer having a plurality of perforations encased in an outer air-injection jacket. The apparatus provides a self-contained system that provides a means for continuously producing a cool (less than about 15° C. preferably less than about 2° C.), stabilized emulsion or foamed product e.g., whipped cream, infused with an alcoholic beverage (i.e., any fluid or solid capable of being converted into a fluid suitable for human consumption and having an alcoholic content of more than 6% by volume, including alcohol). In practice, cream and a flavoring agent and/or liquor are mixed, and then injected into at least one of the one or more mixing chamber assemblies. Sweeteners, and colorings may also be added to the foamable product. Next, pressurized air is introduced into the air-injection jacket and enters a static mixer through a plurality of pinholes to foam the mixture.

A wide variety of fat (e.g., coconut oil, cotton seed oil, peanut oil, and palm oil) or milkfat having a low melting point (less than 32° C.) is preferred. Protein such as casein, sodium caseinate, and Soya protein may be used in the foamed product. An alcoholic beverage containing ethanol such as wine, liqueurs, melasse alcohol, vodka and brandy is preferred. A preferred calcium source is a cream product such as KLEINPETER® whipping cream. Other calcium sources such as liquid cream, milk powder, milk, cream containing carageenan, brand whipping cream (containing 28-35% fat) or heavy whipping cream (containing at least 35% fat) may be used.

In an alternative embodiment, the mixer may be adapted to be used for mixing various chemicals and compounds, including pharmaceutical and oil and gas products. Depending on the chemicals and compounds to be mixed, the cooling system may not be required.

There are several advantages to using this apparatus to combine and mix two or more chemicals or compounds. First, costs are reduced compared to other mixing devices. The novel mixing and foaming apparatus is virtually self-sufficient, and thus reduces the need for human intervention. Second, the operator control system may be programmed to adjust for various viscosities and amounts of chemicals or compounds to be mixed. Third, when producing a dairy-based ingredient (e.g., whipped-cream) infused with an alcoholic beverage, the operator control system prevents false starts and/or splashing by determining if the user is ready to collect the product. Fourth, the apparatus does not require the addition of foam stabilizing agents (e.g., polyphosphates, polysaccharides and lactates) to produce an emulsifying or foamed dairy product with an infused alcoholic beverage. Finally, the apparatus is energy-efficient. Neither electrical whipping devices nor mechanical stirring devices are required.

### EXAMPLE 1

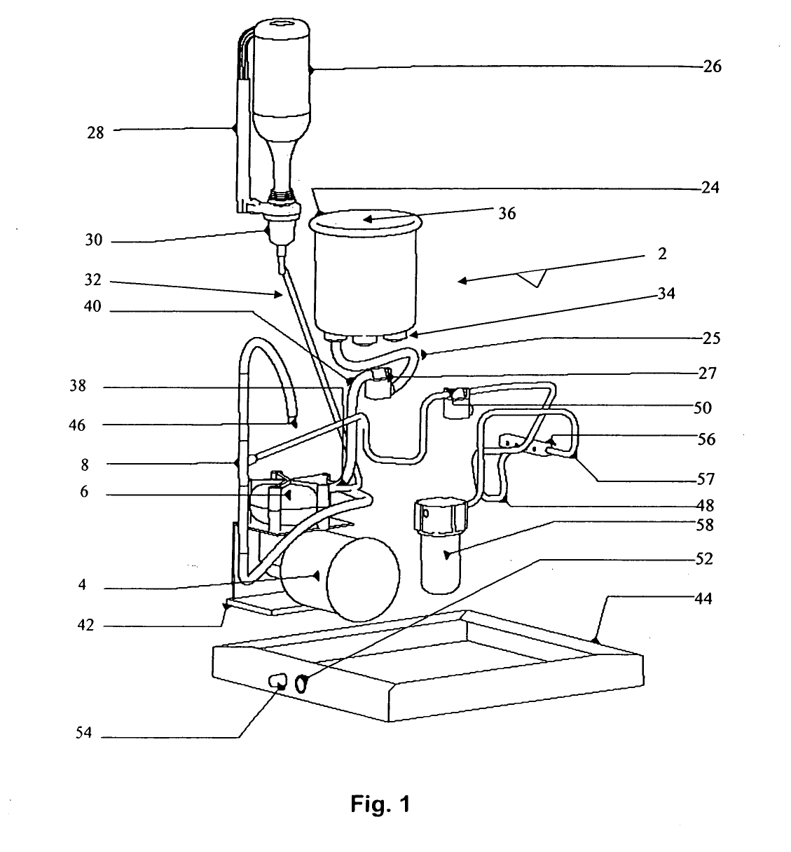

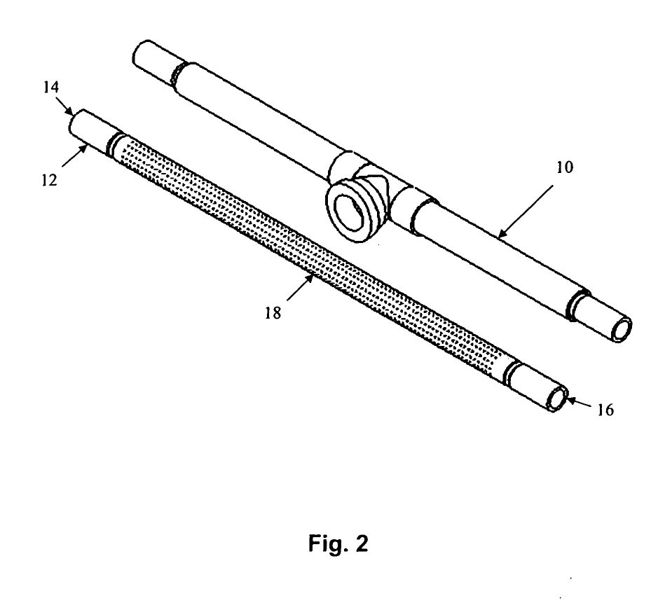

FIG. 1 illustrates schematically a block diagram of the major components of one embodiment of the mixing and foaming apparatus 2. This embodiment comprises an operator control system, a drive motive assembly, one or more mixing chamber assemblies, a cooling chamber, and a liquid supply system. See also FIG. 2. The operator control system comprises an operator control station (“OCS;” not shown; e.g., a Liquid Crystal Display User Interface), a programmable micro-controller (“PMC”) and a relay board. The PMC may be adapted to monitor and control all operation functions. The PMC actively monitored the system (e.g., sensors, sequences, and software) and operation parameters (e.g., temperature, viscosity of the various chemicals or compounds. In one embodiment, the PMC was programmed to perform various functions such as dispensing prescribed amounts of ingredients, timed-outs (e.g., automatically actuating the pump and motor and shutting down the OCS after a pre-selected time of inactivity), cleaning, priming (e.g., a process of extracting air and water trapped in the flow lines and replacing the air and water with cream), and monitoring potential power surges. However, actual operator control is accomplished through the OCS, which allows an operator to monitor and direct various functions such as flavoring, dispensing amounts, and cleaning. The entire dispensing process is preferably programmed into the PMC prior to actual mixing and dispensing operations. The operator initiates start-up and the PMC monitors and controls all other functions, including purge flow control, motive drive, start and stop functions, dispensing, and cleaning.

In the embodiment illustrated in FIG. 1, the drive motive assembly comprises a drive motor 4 having a gear box, a motor control module, and a pump 6. The drive motive assembly provides controlled drive sufficient to accelerate pump 6 to the desired speed. Drive motor 4 functions as the sole source of driving power. Several factors are considered when choosing a drive motor, including power rating, physical size, torque output, operating voltage, and the temperature of the surrounding environment in which the pump is located.

Drive motor 4 in this embodiment is an alternating current induction motor sized to fit within a given operating space either inside or outside the cooling system. Alternatively, drive motor 4 may be a direct current motor. Drive motor 4 and its attached gear box have a drive ratio (i.e., ratio of motor speed to the pump speed) and power sufficient to allow drive motor 4 to controllably spin pump 6 to a predetermine flowrate.

Pump 6 is this embodiment is a peristaltic pump sized to fit within a given operating space. Several factors are considered when choosing a pump, including pressure rating, flowrate, physical size, operating temperature, and sanitary grade (i.e., a material able to minimize the growth of micro-organisms and that is relatively easy to clean and sanitize). The components of the drive motive assembly complement one another such that the pressure differential created by pump 6 is able to draw two or more streams of chemicals or compounds from storage reservoirs and to advance the streams through mixing chamber assembly 8 described below.

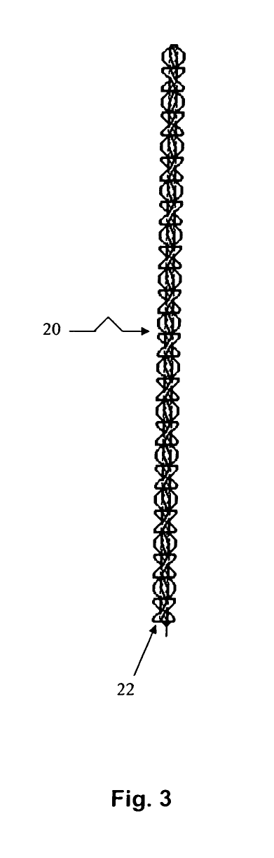

In the embodiment illustrated in FIG. 1, one or more mixing chamber assemblies 8 each comprise an outer tubing 10 (referred to as an “air-injection jacket”) encasing an inner tubing 12 having an inlet 14, an outlet 16, a plurality of pinholes 18 (between about 500 and about 2000 pinholes), and a static mixer 20 located between inlet 14 and outlet 16. See FIG. 2. Static mixer 20 comprises a plurality of perforations 22 sized and configured to induce turbulent mixing of the streams of chemicals or compounds by splitting and diverting the streams as they flow between inlet 14 and outlet 16. See FIG. 3. The components of each mixing chamber assembly 8 complemented one another such that the pressure drop across the static mixer allowed for the ingredients to remain inside mixing chamber assembly 8 for a suitable time to enable adequate mixing. A pressure drop was created along the length of the inner tubing from inlet 14 to outlet 16, which increased the flowrate of the streams and the level at which the streams are agitated. See FIG. 2. Outer tubing 10 was sized and shaped to allow gas supplied either from an external source or an air compressor to flow through pinholes 18 at a rate sufficient to help increase the pressure drop between inlet 14 and outlet 16. See FIG. 2. In this embodiment, the flowrate and pressure of the compressed air, the size and number of pinholes 18 in inner tubing 12, and the shape, and size of static mixer 20 complemented each other such that a mixture of an alcoholic beverage and whipped cream was homogenized to continuously form a stabilized emulsion or foamed product infused with the alcoholic beverage. See FIG. 3. The cooling system (not shown) comprises a conventional refrigerator adapted to allow for the constant cooling of raw products (e.g., whipping cream) at a temperature suited to prevent spoilage and the growth of pathogens.

In the embodiment illustrated in FIG. 1, the liquid supply system comprises a hopper 24 for storing raw material (e.g., whipped cream) and one or more fluidic suppliers 26 mounted to a stand 28 for separately storing liquids such as flavor additives and alcoholic beverages. See FIG. 2. Hopper 24 was adapted to fit within the refrigerator and be accessible from outside, while supplying the raw products to pump 6. Fluidic suppliers 26 were adapted to be mounted on top of the refrigerator and to supply flavor additives and alcoholic beverage to pump 6.

### EXAMPLE 2

Construction of Prototype

A 4.4 ft³ mini refrigerator (Model WC491BG; Avanti, Miami, Fla.) was modified by adding a cream hopper 24 having outside accessibility, an operator control system, a drive motive assembly 4, and five mixing chamber assemblies 8 (only one is shown) each having a static mixer 20 encased in an air-injection jacket 10. Five ports (not shown) were drilled into the top of the mini fridge for mounting of fluidic suppliers 26. A 0.125 in inner diameter hose was attached to each liquid head 30 and to a main line having a diameter of 0.375 in, which supplied liquids along line 32 to pump 6, to introduce an assortment of flavors and liquors into mixing chamber assemblies 8, while preventing cross-contamination between the different flavors and liquors flowing from each fluidic supplier 26. A stand 28 was mounted on top of the mini fridge to support fluidic suppliers 26. A proportional flow pinch valve (not shown; model 0001; Cybotec, Covington, La.) was also connected to each of the 0.125 in inner diameter hoses to control the flow of the flavor additives and liquors corresponding to the desired flavor for eventual dispensing and consumption.

A 1.5 liter cream hopper 24 was made out of stainless steel and had five outlets 34 (only three outlets are shown) for hose connections, which corresponded with the five flavor additives supplied to the mixing chamber assembly 8, and a top opening 36 for adding cream to cream hopper 24.

A hose 25 having a diameter of 0.125 in for each flavor additive and liquor extended from the base of cream hopper 24 to a reducing Tee connector 38 (Model A-31208-47; Cole Palmer, Vernon Hills, Ill.) for mixing with the various flavor additives and liquors, depending of the desired flavor, as they were drawn towards mixing chamber 8 by pump 6 (Model EW-07019-20; Cole Palmer, Vernon Hills, Ill.). A solenoid valve 27 (model #SV61, Valcor Scientific, Springfield, N.J.), was used to control the flow of cream leaving cream hooper 24 and entering line 40. Proportional-type pinch valves (not shown) activated by a small servo-motor (Model 900-00005; Parallax, Rocklin, Calif.) were used to regulate the mixture of cream flowing through line 40 with the flavor additives and liquors as they were drawn into pump 6.

Drive motor 4 (specification: ⅛ hp; 31 inch pounds of torque; and 173 rpm) (model 4Z281; Dayton, Dayton, Ohio) had a right angle gear (not shown) capable of connecting drive motor to pump 6 perpendicularly. Drive motor 4 was attached to bracket 42 and mounted onto base frame 44 for support.

Mixing chamber 8 corresponding to each available flavor were fabricated by encasing an 11 inch, 24 element-mounted static mixer 20 (Model EW-04668-16; Cole Palmer, Vernon Hills, Ill.) in an inner tube 12 having a 0.5 in outside diameter, and then enclosing the inner tube 12 in a 0.5 in inner diameter air-injection jacket 10. Approximately 1300 0.01 inch pinholes 18 were drilled into inner tube 12 to allow compressed air to enter static mixer 20 for agitation of the mixture of cream, flavor additives and liquor to form a foam. A 0.375 in inner diameter tubing was used to route the mixture from pump 6 to inlet 14 of inner tube 12 corresponding to the desired flavor/cream mixture. A 12 element mounted static mixer 46 (Model EW-04668-04; Cole Palmer, Vernon Hills, Ill.) encased in a ⅜ in inner diameter tube was placed between the outlet 16 of inner tube 12 corresponding to the desired flavor and a Valcor solenoid valve (not shown; Model SV61; Valcor Scientific, Springfield, N.J.) was used for dispensing a foamed mixture of cream, flavor additives and liquor.

A generic T-type connector was used to supply compressed air through air hose 48 to air-injection jacket 10 of mixing chamber assembly 8. An air solenoid valve 50 (SV61; Valcor Scientific, Springfield N.J.) was used to regulate the intake of compressed air at 15 psi. A pressure gage 52 (Model EZ3040; Campbell Hausfeld, Harrison, Ohio) and a pressure regulator 54 (Model R261; Poweraire, Anaheim, Calif.) were attached to base frame 44 attached to the incoming air supply to monitor and control air pressure entering mixing chamber 8. A manifold 56 (Model EW-31521-07; Cole Palmer, Vernon Hills, Ill.) was used to route the compressed air to mixing chamber assembly 8 corresponding to the various flavors. A 5 micron filter 58 (Model PA2121; Campbell Hausfeld, Harrison, Ohio) was used to prevent contamination of the air flowing from hose 48 through hose 57 and into air-injection jacket 10.

A programmable micro-controller (not shown; Model 45187; Parallax Inc., Rocklin, Calif.) and a relay board (not shown; Model OME-DB-16R; Omega Engineering Inc., Stamford, Conn.) were mounted in an external housing (not shown) located adjacent to the mini fridge to monitor and control all operation functions by providing voltage to various components of mixing and foaming apparatus 2 when activated by the microcontroller.

### EXAMPLE 3

Dispensing Sequence

A typical operation sequence was as follows: First, a container is placed underneath the dispensing nozzle head. (Optionally, a sensor positioned near the dispensing nozzle head may be used to detect the presence of a container and relay a signal to the microcontroller indicating that a container is present and that the mixing process may begin. If the dispensing cup is removed before the program ends, the process is stopped to prevent spillage.) Next, the microcontroller prompted the user to select a desired flavor. Once the operation specifications of mixing and foaming apparatus 2 (e.g., the dispensing size, flavor selection, etc.) were input to the microcontroller, the microcontroller signaled the relay board to draw cream into the main fluid line by actuating the pump 6 via drive motor 4. Next, the microcontroller signaled the relay to dispense the selected flavor into the main fluid line at the T-type connector 38. Suitable proportions of cream and selected flavor were mixed together as they traveled through the main line. The mixture was then pumped through the inner tubing 12 containing a static mixer 20. Air supplied at a pressure of between about 15 psi and about 25 psi was introduced into air-injection jacket 10 to further agitate the mixture and to create foam. Next, the mixture was introduced into a second static mixer assembly 46 comprising a tubing (not shown) having an inlet, an outlet, and a static mixer located between the inlet and outlet immediately before the exit nozzle to ensure a more uniform distribution of the mixed product. A mixture of cream and flavor was then ejected from the exit nozzle into the container.

Cleaning System

A typical cleaning sequence involves injecting sanitizing water into the cream hopper 36 and allowing the water to flow through all hoses, pumps, air-jackets, and fittings. Next, the hopper 36 is drained, and a burst of clean air purges the system through a drain solenoid to remove any excess water/solvent.

The combination of mechanical components and the versatile controller system allows for easy adjustments of the equipment for different applications and many ingredients. This system can be adapted for mixing of a variety of chemicals and liquids, including food substances and pharmaceuticals. As for mixing of dairy based products, the system can be adjusted to produce various grades of whip cream. The overall system is a self-contained, dairy grade sanitary system to produce a safe and delicious food consumable.

The complete disclosures of all references cited in this specification are hereby incorporated by reference. In the event of an otherwise irreconcilable conflict, however, the present specification shall control.

We claim:

1. A foamed alcoholic product comprising an emulsified mixture of effective amounts of a calcium source, a fat source, a protein source, an alcoholic beverage, without the need for foam stabilizing agents or supplemental foam stabilizing agents.

2. A foamed alcoholic product as recited in claim 1, wherein said foam stabilizing agent is selected from the group consisting of polyphosphates, lactates, polysaccharides and mixtures thereof.

3. A foamed alcoholic product as recited in claim 1, wherein said supplemental foam stabilizing agent is selected from the group consisting of polypropylene glycolalginate, pectin and milk proteins.

4. A foamed alcoholic product as recited in claim 1, wherein said fat source has a melting point less than about 32° C.

5. A foamed alcoholic product as recited in claim 1, wherein said fat source is selected from the group consisting of coconut oil, cotton seed oil, peanut oil, and palm oil.

6. A foamed alcoholic product as recited in claim 1, wherein said protein source is selected from the group consisting of casein, sodium caseinate, and Soya protein.

7. A foamed alcoholic product as recited in claim 1, wherein said alcoholic beverage comprises ethanol.

8. A foamed alcoholic product as recited in claim 7, wherein said alcoholic beverage is selected from the group consisting of wine, liqueurs, melasse alcohol, vodka and brandy.

9. A foamed alcoholic product as recited in claim 1, wherein said calcium source is selected from the group consisting of liquid cream, milk powder, milk, cream containing carageenan, brand whipping cream, and heavy whipping cream.

10. A foamed alcoholic product as recited in claim 1, which is homogenized.

11. A foamed alcoholic product as recited in claim 1, wherein said foamed alcoholic product is cooled to a temperature below about 15° C.

12. A foamed alcoholic product as recited in claim 1, wherein said foamed alcoholic product is cooled to a temperature below about 2° C.

13. A foamed alcoholic product as recited in claim 1, wherein the fat source comprises milkfat.

14. An apparatus for mixing two or more fluids; said apparatus comprising:
(a) an operator control system;
(b) a drive motive assembly; wherein the drive motive assembly comprises a motor, a gear system, and one or more pumps; and wherein said one or more pumps are adapted to receive and eject effective amounts of two or more fluids continuously or intermittently; and
(c) one or more first mixing chamber assemblies; wherein each of the one or more first mixing chamber assemblies comprises an gas-injection jacket encasing an inner tubing having an inlet, an outlet, a plurality of pinholes, and a static mixer located between the inlet and outlet; wherein said one or more first mixing chamber assemblies are adapted to receive the two or more fluids from said one or more pumps and to continuously or intermittently mix the two or more fluids.

15. An apparatus as recited in claim 14, wherein said plurality of pinholes ranges between about 500 and about 2000.

16. An apparatus as recited in claim 14, wherein said apparatus further comprises one or more second mixing chamber assemblies; wherein said one or more second mixing chamber assemblies comprises a tubing having an inlet, an outlet, and a static mixer located between the inlet and outlet.

17. An apparatus as recited in claim 14, wherein the two or more fluids comprise effective amounts of a calcium source, a fat source, a protein source, and an alcoholic beverage.

18. An apparatus as recited in claim 17, wherein the fat source has a melting point less than about 32° C.

19. An apparatus as recited in claim 17, wherein the fat source is selected from the group consisting of coconut oil, cotton seed oil, peanut oil, and palm oil.

20. An apparatus as recited in claim 17, wherein the fat source comprises milkfat.

21. An apparatus as recited in claim 17, wherein the protein source is selected from the group consisting of casein, sodium caseinate, and Soya protein.

22. An apparatus as recited in claim 17, wherein the alcoholic beverage comprises ethanol.

23. An apparatus as recited in claim 22, wherein the alcoholic beverage is selected from the group consisting of wine, liqueurs, melasse alcohol, vodka and brandy.

24. An apparatus as recited in claim 17, wherein the calcium source is selected from the group consisting of liquid cream, milk powder, milk, cream containing carageenan, brand whipping cream, and heavy whipping cream.

25. An apparatus as recited in claim 14, wherein the apparatus further comprises a cooling system for cooling the two or more fluids.

26. A process for producing a stable, foamed emulsion containing alcohol, fat and protein, using the apparatus recited in claim 14, comprising the steps of:
(a) continuously or intermittently introducing effective amounts of a calcium source, a fat source, a protein source, and an alcoholic beverage into one or more of the first mixing chamber assemblies through the one or more pumps; and wherein the apparatus is adapted to permit continuous and simultaneuous mixing in the inner tubing of the effective amounts of calcium source, fat source, protein source, and alcoholic beverage;
(b) flowing the effective amounts of the calcium source, fat source, protein source, and alcoholic beverage from the inlet to the outlet;
(c) inducing turbulent mixing of the effective amounts of the calcium source, fat source, protein source, and alcoholic beverage by splitting and diverting the calcium source, fat source, protein source, and alcoholic beverage as they flow between the inlet and the outlet to form a stable emulsion containing alcohol, fat and protein;
(d) foaming the emulsion by injecting a suitable amount of gas selected from the group consisting of air, nitrous oxide, carbon dioxide, and nitrogen gas from the gas-injection jacket into the inner chamber through the plurality of pinholes; and
(e) ejecting a stable, foamed emulsion containing alcohol, fat and protein from the apparatus.

27. A process as recited in Claim. 25, wherein said process further comprises the step of flowing the emulsified mixture through one or more second mixing chamber assemblies; wherein said one or more second mixing chamber assemblies comprises a tubing having an inlet, an outlet, and a static mixer located between the inlet and outlet before the mixture is ejected from the apparatus.

28. A process as recited in claim 25, wherein the fat source has a melting point less than about 32° C.

29. A process as recited in claim 25, wherein the fat source is selected from the group consisting of coconut oil, cotton seed oil, peanut oil, and palm oil.

30. A process as recited in claim 25, wherein the fat source comprises milkfat.

31. A process as recited in claim 25, wherein the protein source is selected from the group consisting of casein, sodium caseinate, and Soya protein.

32. A process as recited in claim 25, wherein the alcoholic beverage comprises ethanol.

33. A process as recited in claim 32, wherein the alcoholic beverage is selected from the group consisting of wine, liqueurs, melasse alcohol, vodka and brandy.

34. A process as recited in claim 25, wherein the calcium source is selected from the group consisting of liquid cream, milk powder, milk, cream containing carageenan, brand whipping cream, and heavy whipping cream.

35. A process as recited in claim 25, wherein the apparatus further comprises a cooling system for cooling.

36. A process as recited in claim 25, wherein said process further comprises the step of cooling the stable emulsion containing alcohol, fat and protein to a temperature below about 15° C.

37. A process as recited in claim 25, wherein said process further comprises the step of cooling the stable emulsion containing alcohol, fat and protein to a temperature below about 2° C.
